(19) United States
(12) Patent Application Publication
(10) Pub. No.: US 2012/0060173 A1
(43) Pub. Date: Mar. 8, 2012

(54) SYSTEM AND METHOD FOR ENHANCED ALERT HANDLING

(76) Inventor: James Malnati, Stillwater, MN (US)

(21) Appl. No.: 12/874,287

(22) Filed: Sep. 2, 2010

(51) Int. Cl. G06F 9/46

(52) U.S. Cl. 719/318

(57) ABSTRACT

The disclosure relates generally to computer system management systems, and more specifically to enhanced alert handling within computer system management systems. In one embodiment, responsive to an Alert raise event occurring in a computer system management application, execution of an enhanced alert handling routine on a processor-based device is triggered. The enhanced alert handling routine determines whether description field filtering by a resource monitor was the source of the Alert. For instance, the enhanced alert handling routine may determine whether a source of the Alert was matching of a user-defined description in an event log for the managed computer system. When determined that such description field filtering was the source of the Alert, the enhanced alert handling routine clears the Alert and re-raises the Alert with a unique alert-ID. Because the Alert is re-raised with a unique alert-ID, it is not discarded by the management application as a duplicate.

### CROSS-REFERENCE TO RELATED APPLICATIONS

The following co-pending and commonly-assigned patent applications have at least some subject matter in common with the current application, all of which are hereby incorporated herein by reference: U.S. patent application Ser. No. 12/644,517 [Unisys Control No. RA5893] titled “Systems, methods, and computer program products for managing object alerts,” and U.S. patent application Ser. No. 12/637,928 [Unisys Control No. RA5888] titled “Method, apparatus, and computer program product for generating audible alerts.”

### TECHNICAL FIELD

The below description relates generally to computer system management systems, and more specifically to enhanced alert handling within computer system management systems.

### BACKGROUND

Software applications referred to herein as computer system “management applications” are often implemented for monitoring, controlling, and/or otherwise managing the operation of one or more computer systems (i.e., the “managed computer system(s)). Computer systems (e.g., information technology systems) are essential to any modern business. These systems have and continue to grow increasingly more complex. For instance, such systems may include distributed centers located anywhere from a few miles apart to those across the continent or in separate countries. Today, personal computers are common and many businesses employ multiple operating systems from various vendors. Often, systems of a company are dispersed in branch offices running critical applications or containing essential data. One exemplary type of computer system management application is that referred to as a Single Point Operations software, which supports centralized control and automated operations of multiple data processing systems.

Tools, such as management applications, are available that integrate operational control of multiple heterogeneous mainframes and distributed systems. These systems include numerous components that need to be managed. Typically, managed objects are used to view, monitor, and manage these components. The managed objects are typically predefined in operational software (e.g., in a management application) for managing the components of the system. For instance, such systems may employ filters that compare managed objects to a property threshold, whereby an alert is raised on a managed object when a property of the object satisfies the threshold.

Many computer system management applications allow users to define rules and corresponding actions that the application is to automatically trigger upon the conditions that it monitors satisfying the defined rules. For instance, a management application may allow a user to define one or more message-matching rules that specify certain messages that the management application receives/detects (e.g., system messages generated by one or more monitored computer systems), and the rules may further specify one or more actions that are to be triggered by the management application upon such a message match.

As an example, Single Point Autoaction Message System (SP-AMS) software is an automation language contained in Operations Sentinel® by Unisys® Corporation (hereafter referred to as “Operations Sentinel”). SP-AMS is a utility that allows a user to specify messages to match and actions to automatically perform (e.g., without operator interaction) when a message is received and matched. ClearPath Plus OS 2200 Autoaction Message System (CP-AMS) is also part of Operations Sentinel. SP-AMS automates system operations for MCP and UNIX systems and partitions; and CP-AMS automates system operations for OS 2200 partitions in a ClearPath Plus server.

Operations Sentinel uses a ClearPath (CP)-AMS autoaction database associated with each OS 2200 console and an SP-AMS autoaction database associated with managed UNIX, MCP, and Linux partitions, to identify system messages and automatically execute actions. These actions can include raising alerts that are displayed in the Alerts window of Operations Sentinel Console. In addition to displaying alerts, a user may create rules to activate external paging devices (or other communication/notification devices, such as mobile telephones, etc.) when an alert is raised, acknowledged, or cleared. Actions may also include cross-system commands sent to another managed system.

A management application may employ a resource monitor, which may be implemented on a managed computer system for monitoring certain resources of the managed computer system. For instance, a resource monitor may monitor event logs that are populated with events generated by the managed computer system (e.g., by the managed computer system's operating system). As an example, Operations Sentinel contains a component that monitors resources on Windows systems (i.e., a managed computer system running a Windows-based operating system), called the Windows Resource Monitor (“WRM”). The WRM may monitor various resources, such as disk drives, CPU, memory, as well as the Windows event logs.

By default, Windows events are logged to one of three event log files (within event logs 204 shown in FIG. 2):

System log;

Security log; and

Application log.

Event log filtering may be performed by the management application (e.g., by the WRM), and alerts may be raised based on such filtering. For example, a user of the management application may desire to have an alert raised when an event log entry is made that contains certain information. Thus, for instance, a user/operator of the management application may specify certain content that is be detected as occurring in the description field of the event log entries, and upon a positive match of the specified content being detected in the description field of an event log entry an alert may be raised.

As an example, the conventional WRM of Operations Sentinel monitors messages that are written to the event logs and raises an alert if a particular phrase appears in the event log file. The administrator may specify the log files to monitor and, for each log file, phrases to search for in the log file. The phrase can be fixed text or a regular expression.

With the conventional WRM in Operations Sentinel, it is possible to match Description fields in multiple Event Log entries, but identical alerts are raised in this eventuality. Thus, such identical alerts appear to be duplicates, and by design, such duplicate alerts are discarded. Therefore, improvements are desirable.

### SUMMARY

As mentioned above, with the conventional WRM in Operations Sentinel, it is possible to match Description fields in multiple Event Log entries, but identical alerts are raised in this eventuality. Thus, such identical alerts appear to be duplicates, and by design, such duplicate alerts are discarded. However, in this instance (e.g., when description fields are matched in multiple event log entries), a new alert may be desirable for each of the event log entries.

In Operations Sentinel, the following attribute-value pairs are included in an alert event report:

TYPE, which has a value of AL for all alerts.

CLASS, which indicates the object type.

INSTANCE, which is the name of the object (system) to which the alert applies.

SEV, which indicates the severity of an alert to be raised, or if an alert is to be acknowledged or cleared.

APPL, which names the source of the event.

ALERTID, which identifies the type of alert that is to be raised, acknowledged, or cleared.

TEXT, which is the text displayed in the Alerts window of Operations Sentinel Console; required when the event report raises an alert and optional when the event report acknowledges or clears an alert.

When an alert event report raises an alert, Operations Sentinel retains this alert and discards any subsequent event reports that raise the same alert. In Operations Sentinel, two alerts are considered to be identical if all of the following attributes are the same:

CLASS (object class)

INSTANCE (object name)

ALERTID (alert identifier)

ALERTQUAL (alert qualifier)

APPL (application name)

SEV (severity).

CLASS, INSTANCE, ALERTID, ALERTQUAL, and APPL are the attributes that identify the alert. When SEV is also identical in two raise-alert event reports, the second event report is conventionally discarded if the alert raised by the first event report has not been cleared.

A user may define a filter that would match Description fields in separate, but similar, Event Log entries. For instance, a phrase may be defined that would match the following description fields in Event Log entries:
“Match multiple description line”
“Match multiple description lines”
“Match multiple description lines that contain any additional text.”
   The match would result in identical alerts being raised, which would appear to be duplicates, and thus by design, those duplicate alerts would be discarded. For each of the three Description lines above, the user expects to see three alerts appear. In fact, only the first alert is raised and the remaining two are discarded (as being duplicates) with the conventional standard Operations Sentinel product. The present disclosure allowes the user to decide when this normal policy should be over ridden to allow additional alerts.

An alert is raised in Operations Sentinel by setting the severity (SEV) attribute in an alert event report to any valid value other than clear or acknowledge, such as critical, major, minor, warning, informational, or indeterminate.

Conventionally in Operations Sentinel, all alerts from the Event Log filtering portion of the WRM must be raised with non-configurable severities. For example, an alert of “major” severity occurs if the event is of type “Error.” This “major” level of concern does not apply to many “error” type alerts. Similarly, “Warning” and “Information” level severities in the Event Log conventionally must be raised with these same severities, and this is not always desirable.

Thus, this disclosure relates generally to enhanced alert handling. According to certain embodiments of the present disclosure, the management application gathers information from the current alert, clears it, and raises it with a unique alert-id so additional (but similar) alerts may be raised.

Certain embodiments for alert handling described herein allow for a different mapping of Event Log exceptions to generated alert severities.

In the conventional Unisys Operations Sentinel automation product, the Alert Policy may be used to invoke programs in response to alert raise, acknowledge, or clear events. The Alert Policy and a specially written program may be used to address the issues identified above. Each Alert Policy action is provided with all attributes from the current alert. These are passed as environment variables to the invoked program. The program may therefore clear the existing alert (making a new alert possible in the future) and raise a similar alert with a unique alert-id.

In certain embodiments, the alert severity may also be changed if desired, which addresses one of the issues within the conventional WRM of Operations Sentinel, as noted above. The statically-defined alert levels may not be appropriate and one of the following levels may be automatically selected after an enhanced alert handler program parses the alert text and/or other attributes:
Indeterminate
Informational
Warning
Minor
Major
Critical
The alert may also be automatically cleared (and not re-raised) if necessary.

In one embodiment, a method for enhanced alert handling for computer system management is provided. Responsive to an Alert raise event occurring in a computer system management application, execution of an enhanced alert handling routine on a processor-based device is triggered. The enhanced alert handling routine determines whether description field filtering by a resource monitor was the source of the Alert. For instance, the enhanced alert handling routine may determine whether a source of the Alert was matching of a user-defined description in an operating system event log for the managed computer system. When determined that such description field filtering was the source of the Alert, the enhanced alert handling routine clears the Alert and re-raises the Alert with a unique alert-ID. Because the Alert is re-raised with a unique alert-ID, it does not appear as a duplicate and is thus not discarded as a duplicate.

Further, in certain embodiments, the enhanced alert handling routine may assign the re-raised Alert a different severity level than that assigned to the cleared Alert. Thus, greater flexibility is afforded to assignment of severity level to the re-raised Alert by the enhanced alert handling routine, rather than being restricted to assigning statically-defined alert levels for the alerts arising from the resource monitor description field filtering. In certain embodiments, user-defined rules (e.g., associated with the user-defined description field filtering that gave rise to the Alert) may be used by the alert handling routine for selecting (e.g., by processing the alert text and/or other attributes against the user-defined rules) the appropriate severity level to assign the re-raised Alert.

### BRIEF DESCRIPTION OF THE DRAWINGS

For a more complete understanding of the present teachings, reference is now made to the following description taken in conjunction with the accompanying drawings.

FIG. 1 is a block diagram of an operational system for managing a large computing distributed computing system adapted according to one example embodiment;

FIG. 2 shows a block diagram for an exemplary system that illustrates the relationship between a managed system, a resource monitor executing on the managed system, and a management application (e.g., Operations Sentinel) in accordance with one embodiment of the present disclosure.

FIG. 3 shows an exemplary graphical user interface provided by Operations Sentinel that permits users to define expressions to be used by the WRM in matching Description fields in event logs for a managed computer system in accordance with one embodiment of the present disclosure.

FIG. 4 shows an exemplary graphical user interface that shows the default Action List in the Alert Policy in Operations Sentinel according to one embodiment of the present disclosure.

FIG. 5 shows an exemplary operational flow diagram for one embodiment of the present disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to enhanced alert handling. According to certain embodiments of the present disclosure, a management application (e.g., an enhanced alert handling routine/program) gathers information from a current alert, clears it, and raises it with a unique alert-id so additional (but similar) alerts may be raised. Certain embodiments for alert handling described herein allow for a different mapping of Event Log exceptions to generated alert severities.

In the conventional Unisys Operations Sentinel automation product, the Alert Policy may be used to invoke programs in response to alert raise, acknowledge, or clear events. In accordance with one embodiment of the present disclosure, the Alert Policy and a specially written program may be used to address the issues identified above. For instance, in one embodiment, each Alert Policy action is provided with all attributes from the current alert, and these may be passed as environment variables to the invoked enhanced alert routine. The enhanced alert handling routine may, in one embodiment, clear the existing alert (making a new alert possible in the future) and raise a similar alert with a unique alert-id.

In certain embodiments, the alert severity may also be changed if desired, which addresses one of the issues within the conventional WRM of Operations Sentinel, as noted above. The statically-defined alert levels may not be appropriate and one of the following levels may be automatically selected after the management application (or enhanced alert handling routine that may be invoked as mentioned above) parses the alert text and/or other attributes:
Indeterminate
Informational
Warning
Minor
Major
Critical
The alert may also be automatically cleared (and not re-raised) if necessary.

An exemplary management application with which certain embodiments of the present disclosure may be employed for enhanced alert handling includes, without limitation, the Operations Sentinel® by Unisys® Corporation. For more information about Operations Sentinel®, see e.g., ClearPath Enterprise Servers: Operations Sentinel Administration and Configuration Guide, Operations Sentinel Level 11.0, September 2008 (7862 2321-010), the disclosure of which is hereby incorporated herein by reference.

Further, exemplary managed computer systems and management applications with which certain embodiments of the present disclosure may be employed for enhanced alert handling include, without limitation, those described in U.S. Pat. No. 6,154,787 titled “Grouping shared resources into one or more pools and automatically re-assigning shared resources from where they are not currently needed to where they are needed,” U.S. Pat. No. 7,092,940 titled “Automation of complex user-level command sequences for computing arrangements,” U.S. Pat. No. 7,421,492 titled “Control arrangement for operating multiple computer systems,” U.S. Pat. No. 7,543,027 titled “Operator messaging within an environment for operating multiple computing systems,” co-pending U.S. patent application Ser. No. 12/644,517 [Unisys Control No. RA5893] titled “Systems, methods, and computer program products for managing object alerts,” and co-pending U.S. patent application Ser. No. 12/637,928 [Unisys Control No. RA5888] titled “Method, apparatus, and computer program product for generating audible alerts,” the disclosures of which are hereby incorporated herein by reference.

In certain embodiments, the management application may employ object-oriented programming for managing various components of the computing system as managed objects. Object-oriented programming uses primarily classes and objects. A class creates a new type where objects are instances of the class. Objects can store data using ordinary variables that belong to the object. Variables that belong to an object or class are called fields. Objects can also have functionality by using functions that belong to a class. Such functions are called methods of the class. Collectively, the fields and methods can be referred to as the attributes of that class. Fields can belong to each object of the class or they can belong to the class itself

Classes are created in the source code itself by using the class statement followed by the name of the class. An object of the class can then be created. Class variables are shared by all objects of that class. There is only one copy of the class variable, and when an object makes a change to a class variable, the change is reflected in all other objects as well. Object variables are owned by each object and are not shared. Subclasses can also be used that inherit the properties of the parent class, but can also have additional defined properties. Instance is the name of a single managed object associated with an actual system on the network.

The management application may generate alerts based on object states. An example alert might be that a disk drive, an object of the managed system, is close to full. An alert can be sent via an alert event report that requires the recipient of the report to be identified in Class and Instance properties of the event report.

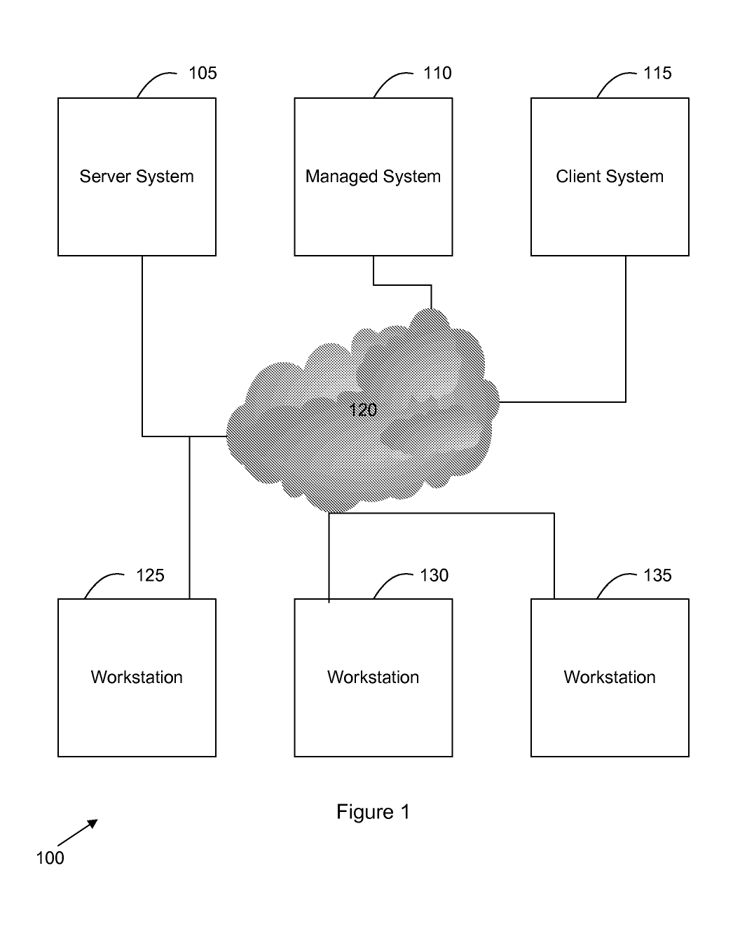

FIG. 1 is a block diagram of an operational system for managing a large distributed computing system 100. The system 100 includes a server system 105, a managed system 110, computer workstations 125, 130, 135, and a client system 115, as is well known in the art. The server system 105, managed system 110, computer workstations 125, 130, 135 and the client system 115 preferably communicate with one another over a network 120, which can be any suitable network such as a LAN, WAN, or any other network.

In one exemplary embodiment, the server system 105 acts as a maintenance processing system and/or a utility monitoring processing system that functions to monitor the activities and health of the components, processes, and tasks executing within the managed system 110. The managed system 110 performs the processing desired by the operators of the managed system 110. Client system 115 includes processing systems utilized by operators of the managed system 110 to view operations, maintenance and health information regarding the components, processes and tasks in the managed system 110. Furthermore, any one or more of the computer workstations 125, 130, and 135 may include processing systems utilized by operators of the managed system 110 to view operations, maintenance and health information regarding the components, processes and tasks in the managed system 110. In some embodiments, the client system 115 may, itself, be a computer workstation that is a peer of the workstations 125, 130, 135. In the embodiment shown in FIG. 1, these systems are shown to be separate processing systems. One of ordinary skill in the art will recognize that these systems may be implemented to operate on one as well as numerous hardware systems without deviating from the spirit and scope of the present invention as recited within the attached claims.

In one example embodiment, Operations Sentinel® by Unisys® provides an operational environment for managing large computing systems, such as the computing system 100. Operations Sentinel® includes a Graphical User Interface (GUI) for managing alerts in the computing system. Specifically, Operations Sentinel® provides visual and/or audible alerts at the server system 105. Additionally or alternatively, one or more of the server system 105, the client system 115, and the computer workstations 125, 130, 135 includes a utility for generating visual and/or audible alerts of system conditions. It may also be the case that some alerts are directed to certain ones of the workstations and not to others. In addition, a GUI is provided in some embodiments so that commands may be sent to portions of the system generating the alert without the overhead of starting the Operations Sentinel® GUI at the server system 105 or the actual system console. Use of commands may be restricted on some ones of the workstations 125, 130, 135 according to established user permission. While reference is made to Operations Sentinel®, it is understood that various embodiments are applicable to any monitoring system for a distributed computing system.

An exemplary management application with which certain embodiments of the present disclosure may be employed for enhanced alert handling includes, without limitation, the Operations Sentinel® by Unisys® Corporation. The Operations Sentinel and its Windows Resource Monitor (WRM), server, console, and other components with which embodiments of the present disclosure may be implemented are discussed below to aid the reader in understanding one exemplary environment in which the proposed enhanced alert handling may be implemented. Further information regarding Operations Sentinel and its WRM, server, console, and other components can be found in ClearPath Enterprise Servers: Operations Sentinel Administration and Configuration Guide, Operations Sentinel Level 11.0, September 2008 (7862 2321-010), the disclosure of which is incorporated herein by reference. Of course, while the below-described implementation contains details that are specific to Operations Sentinel and its WRM and other components, embodiments of the present disclosure are not so limited in application, but may be readily adapted for implementation with other computer management applications and resource monitors, as those of ordinary skill in the art will appreciate.

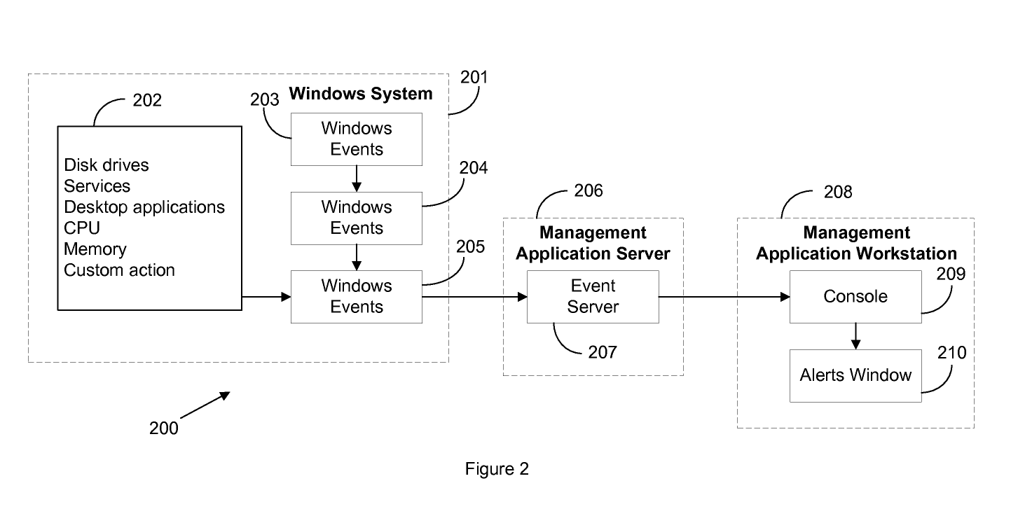

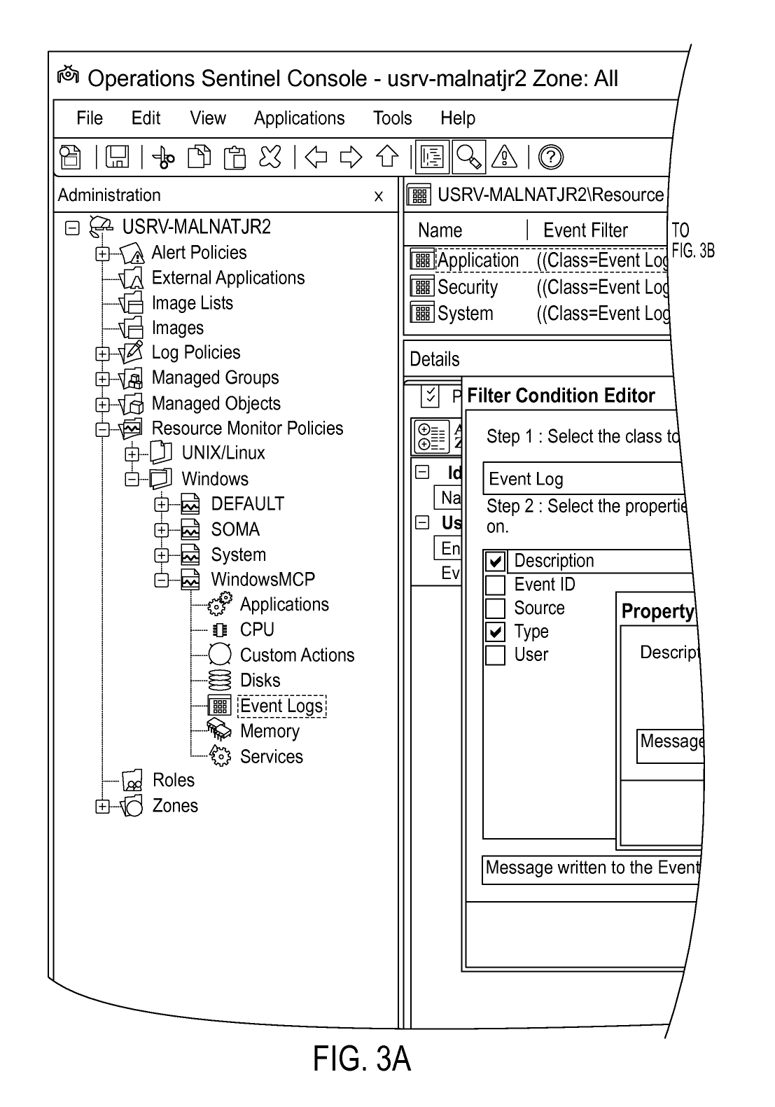

FIG. 2 shows a block diagram for an exemplary system 200 that illustrates the relationship between each managed Windows system 201, the Windows Resource Monitor (WRM) 205 installed on it, and management application (e.g., Operations Sentinel) components in accordance with one embodiment of the present disclosure. This shows one exemplary system environment 200 in which embodiments of the present disclosure for enhanced alert handling may be implemented. While a Windows system is shown and described as the managed system 201 in FIG. 2, it should be recognized that in other embodiments the managed system may have a different type of operating system (e.g., UNIX, etc.), and a resource monitor (like WRM 205) may be similarly implemented to monitor event logs containing events from such system. Thus, embodiments of the present disclosure are not limited in application to management of systems having Windows-based operating systems.

The managed Windows system 201 may include various managed resources 202 implemented thereon, such as disk drives, CPU, desktop applications, memory, etc. The Windows Resource Monitor 205 receives Windows events 203 from the Windows event logs 204 and reports them to the management application server 206 (e.g., an Operations Sentinel server). The management application console 209 (e.g., Operations Sentinel Console), which may be implemented, for example, on a management application workstation 208 (e.g., Operations Sentinel workstation), displays the events in its Alerts window 210.

An exemplary implementation of a computer management application that may be implemented in the manner shown in FIG. 2 is described further below with reference specifically to the Operations Sentinel® management application by Unisys® Corporation. Again, the Operations Sentinel with which embodiments of the present disclosure may be implemented are discussed below to aid the reader in understanding one exemplary environment in which enhanced alert handling may be implemented. Of course, while the below-described implementation contains details that are specific to Operations Sentinel, embodiments of the present disclosure are not so limited in application, but may be readily adapted for implementation with other computer management applications for the enhanced alert handling described further herein, as those of ordinary skill in the art will appreciate.

Operations Sentinel can monitor the following components as Windows systems:
Operations Sentinel servers;
Operations Sentinel workstations;
Windows partitions of ClearPath Plus and ES7000 servers; and
Service Processors of ClearPath Plus and ES7000 servers.

The Windows Resource Monitor (WRM) 205 may monitor events 203 on each Windows partition, server, and workstation on which it is installed, and reports those events to the server 206. On a Windows system, an event 203 is any significant occurrence that requires notification to the user. By default, Windows events are logged to one of three event log files (within event logs 204 shown in FIG. 2):

System log;

Security log; and

Application log.

WRM 205 converts Windows events 203 to Operations Sentinel alerts. If the Windows system 201 is part of the current zone being monitored/managed by the console 209, the Operations Sentinel Console 209 includes these alerts with the zone alerts. If the system 201 is not part of the current zone being monitored/managed, the Operations Sentinel Console includes them with the other alerts. Operations Sentinel handles these alerts in the same manner as other alerts.

The WRM 205 is packaged with Operations Sentinel and has two main components:
Windows Resource Monitor (the agent software). The Windows Resource Monitor is installed and configured on each managed Windows system 201.
A resource monitor policy that is defined and maintained in Administration mode of Operations Sentinel Console.

A resource monitor policy indicates what resources are monitored and how they are managed by the WRM 205 on a managed system 201. Operations Sentinel Console 209 provides the capability to define Windows systems for resource monitoring, create and modify resource monitor policies, and push resource monitor policies to the Windows systems. The resource monitoring policy is delivered to the managed Windows system 201 when explicitly requested by the Operations Sentinel administrator, and upon receipt is verified and stored on the managed Windows system 201.

WRM 205 supports monitoring of the following resource groups 202:

Disk drives. WRM 205 raises an alert if the minimum free space on a disk drive falls below a threshold. WRM 205 automatically clears the alert when the free space exceeds the threshold. The administrator specifies the file disk drives to monitor and usage thresholds for each disk drive.

Services. WRM 205 raises an alert when a service is in an unexpected state (‘up’ or ‘down’). WRM 205 automatically clears the alert when the service returns to the expected state. The administrator specifies critical services to monitor and the unexpected state of each service.

Desktop applications. WRM 205 raises an alert if it detects a hung condition or when a process is in an unexpected state (‘up’ or ‘down’). WRM 205 automatically clears the alert when the process returns to the expected state. The administrator specifies the applications to monitor and the unexpected state of each process.

CPU. WRM 205 raises an alert if central processing unit (CPU) usage remains above the threshold value for a period of time. The time period is used to avoid alerts for momentary spikes in CPU usage. WRM 205 automatically clears the alert when CPU usage falls below the threshold.

Memory. WRM 205 raises an alert if memory usage remains above the threshold value for a period of time. The time period is used to avoid alerts for momentary spikes in memory usage. WRM 205 automatically clears the alert when memory usage falls below the threshold. The administrator defines the memory usage threshold as a percent in use.

Event logs. WRM 205 raises an alert if a particular phrase appears in an event log file 204. WRM 205 monitors messages that are written to the event logs 204 and raises an alert if a particular phrase appears in the log file 204. The administrator specifies the log files to monitor and, for each log file, phrases to search for in the log file. The phrase can be fixed text or a regular expression.

Custom actions. WRM 205 provides custom actions as a method to use scripts or programs to extend the capabilities of WRM 205. An administrator defines in the resource monitor policy the name of the script or program, the arguments to pass to the script or program, and whether to cyclically execute the script or program. Any scripting or programming language can be used to write the scripts and programs. WRM 205 starts the script or program that monitors the resource. The custom action is configured to start the script or program once or periodically (based on the interval defined in the policy). When the monitoring conditions are met, the script or program posts events to the Operations Sentinel server 206.

WRM 205 lets the administrator enable or disable monitoring for the entire policy (to account for scheduled maintenance) or for individual resource groups (for debugging and testing). Changes take affect immediately after the policy is pushed to the managed Windows system 201. These changes only apply to the affected resource groups and do not disrupt monitoring of other resource groups.

Operations Sentinel provides a default resource monitor policy (called DEFAULT) to monitor a typical set of resources 202 on a Windows system 201. A site can either

Use the default resource monitor policy as is;

Copy the default resource monitor policy and alter some of the threshold or key phrase definitions; or

Create a new resource monitor policy.

Resource monitor policies are created, maintained, and pushed to the managed system 201 through the Resource Monitor Policies node in Administration mode in Operations Sentinel Console 209. By using the Resource Monitor Policies node, an administrator can control how each resource is managed by defining the properties of each resource. In addition, all resource groups have an Interval property that controls the polling interval (the time between checks of a resource).

Operations Sentinel Console 209 saves resource monitor policies in the Operations Sentinel data folder on the Operations Sentinel server 206. A new or updated resource monitor policy is pushed to the Windows system 201 for changes to take effect. Operations Sentinel Console 209 reports any errors that are encountered while changing policies or attempting to push the policy to a system.

Custom actions provide a method to monitor and take actions that WRM 205 does not provide with its predefined monitoring capabilities. Typically, the custom action monitors a resource 202 on the managed system 201 or detects a condition and then sends information to Operations Sentinel. However, it could also perform some action on the managed system 201 and report the results back to Operations Sentinel.

The procedure to implement a custom action is as follows:

1. Define the custom action in the resource monitoring policy.

2. Create the actual script or program. Custom actions can use an existing script or program but more typically it uses a script or program that is specifically written for the custom action. The custom action script or program can be written in any language available for the platform.

To aid reporting of resource information, the custom action's STDOUT is redirected to the pipe file automatically. Scripts or programs write event reports to STDOUT and WRM 205 reads the data and sends it to the Operations Sentinel server 206. Rather than using STDOUT, scripts or programs can write event reports directly to the pipe that WRM 205 monitors.

Windows events 203 received by WRM 205 are converted to alert event reports and sent to the Operations Sentinel server 206. These event reports can trigger alert actions in the active alert policy. The ALERTID of these event reports is a combination of two components of the Windows event 203 that originated the alert event report separated by a colon (:). These components are
The source that reported the event to Windows, which then logged it; and
The event ID or message number assigned to the event based on a coding system defined by Microsoft.

If the ALERTID matches the name of an action list in the active Operations Sentinel alert policy, the raise actions in the action list are initiated. For instance, consider the following example:
The ALERTID value NETLOGON:3095 indicates that the NETLOGON service was started on a Windows system 201 that is part of a workgroup rather than a domain. If the active alert policy contains an action list named NETLOGON:3095, then all raise actions in this list are executed when WRM 205 raises the alert.

In Operations Sentinel, the following attribute-value pairs are included in an alert event report:

TYPE, which has a value of AL for all alerts.

CLASS, which indicates the object type.

INSTANCE, which is the name of the object (system) to which the alert applies.

SEV, which indicates the severity of an alert to be raised, or if an alert is to be acknowledged or cleared.

APPL, which names the source of the event.

ALERTID, which identifies the type of alert that is to be raised, acknowledged, or cleared.

TEXT, which is the text displayed in the Alerts window of Operations Sentinel Console; required when the event report raises an alert and optional when the event report acknowledges or clears an alert.

When an alert event report raises an alert, Operations Sentinel retains this alert and discards any subsequent event reports that raise the same alert. In Operations Sentinel, two alerts are considered to be identical if all of the following attributes are the same:

CLASS (object class)

INSTANCE (object name)

ALERTID (alert identifier)

ALERTQUAL (alert qualifier)

APPL (application name)

SEV (severity).

CLASS, INSTANCE, ALERTID, ALERTQUAL, and APPL are the attributes that identify the alert. When SEV is also identical in two raise-alert event reports, the second event report is conventionally discarded if the alert raised by the first event report has not been cleared.

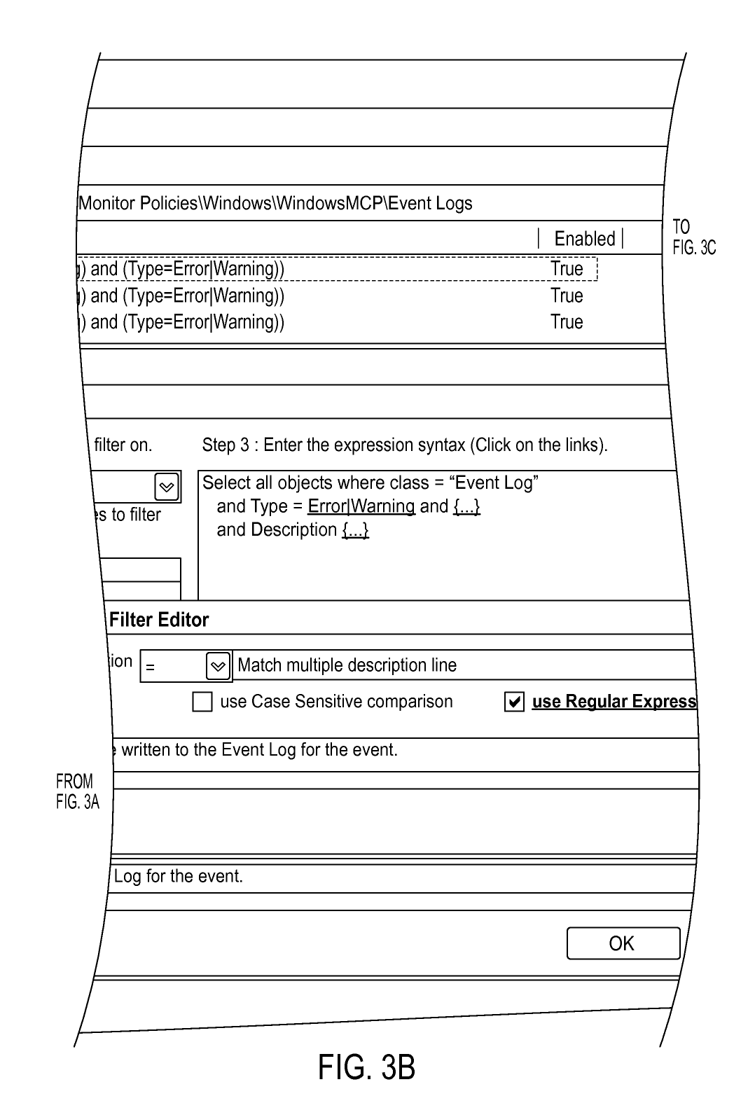

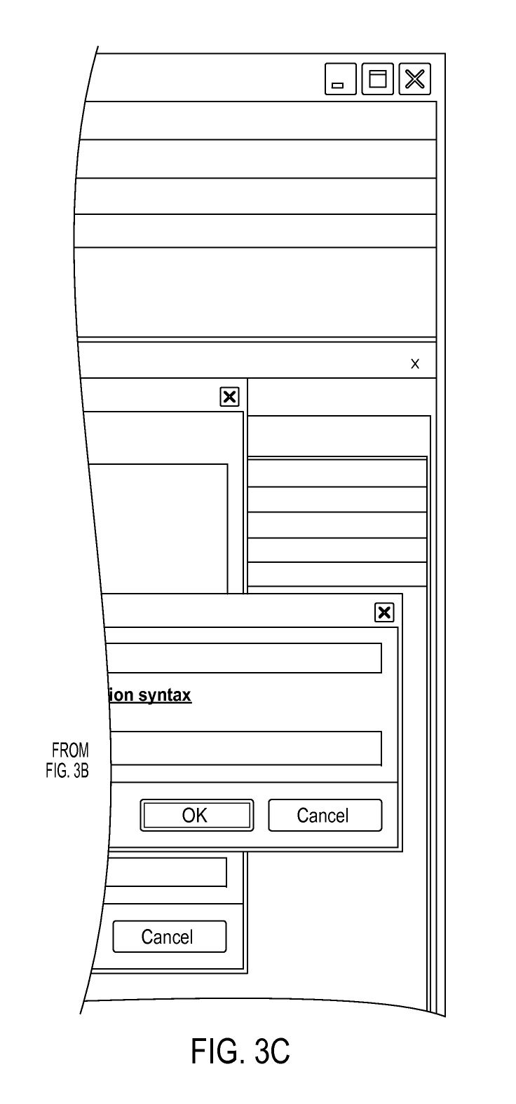

The Windows Event Log filtering component of WRM in Operations Sentinel permits regular expressions that allow users to match multiple Description fields. This is highly desirable and is illustrated in the exemplary screen capture shown in FIG. 3. The illustrative filter defined in the example shown in FIG. 3 would match Description fields in separate, but similar, Event Log entries. For instance:
“Match multiple description line”
“Match multiple description lines”
“Match multiple description lines that contain any additional text.”

Again, this is the desired behavior, but what is often not desirable happens next. For each of the three Description lines above, the user expects to see three alerts appear because the alerts appear in separate event log entries. In fact, only the first alert is raised and the remaining two are discarded with the standard Operations Sentinel product.

A further issue is that all alerts from the Event Log filtering portion of WRM conventionally must be raised with non-configurable severities. For example, an alert of “major” severity occurs if the event is of type “Error” (there are five other possibilities). This level of concern does not apply to many “error” type alerts. Similarly, “Warning” and “Information” level severities in the Event Log conventionally must be raised with these same severities, and this is not always desirable.

Certain embodiments for alert handling described herein allow for a different mapping of Event Log exceptions to generated alert severities.

In the conventional Unisys Operations Sentinel computer system management application, the Alert Policy may be used to invoke routines/programs in response to alert raise, acknowledge, or clear events. The Alert Policy and a specially written computer-executable routine or program (which may be referred to herein as an enhanced alert handling routine) may be used to address the issues identified above. Each Alert Policy action is provided with all attributes from the current alert. These are passed as environment variables to the invoked enhanced alert handling routine. The routine may therefore clear the existing alert (making a new alert possible in the future) and raise a similar alert with a unique alert-id.

In certain embodiments, the alert severity may also be changed if desired, which addresses one of the issues within the conventional WRM of Operations Sentinel, as noted above. The statically-defined alert levels may not be appropriate and one of the following levels may be automatically selected after the enhanced alert handling routine parses the alert text and/or other attributes:
Indeterminate
Informational
Warning
Minor
Major
Critical
The alert may also be automatically cleared (and not re-raised) if necessary.

This is accomplished by using the “default” Action List in the Alert Policy. The enhanced alert handling routine described herein is, in one embodiment, invoked for all alert raise events, but quickly determines whether it should take action or terminate immediately. In one embodiment, this is done by the enhanced alert handling routine examining the alert attributes and deciding whether WRM Description field filtering was the source of the alert. If determined that the WRM description field filter was the source of the alert, the alert is cleared, and some interface with the computer system management application (e.g., the Operations Sentinel Pipe or Application Programming Interface (API)) is used by the enhanced alert handling routine to raise a similar alert with a unique alert-id. For example, if a user is filtering these events by the description field, they wish to have all alerts raised as unique, even if they are very similar or identical. In most cases the text of the alert will vary, but that is not guaranteed. The user does not mind the risk of completely identical, duplicate alerts as they want to be sure that they are seeing all alerts when using a wild card that could match many similar alerts. It is an approach that sacrifices convenience (more alerts need to be cleared manually) for certainty (no potentially important alerts will be lost because they have the same alert-id as an existing alert).

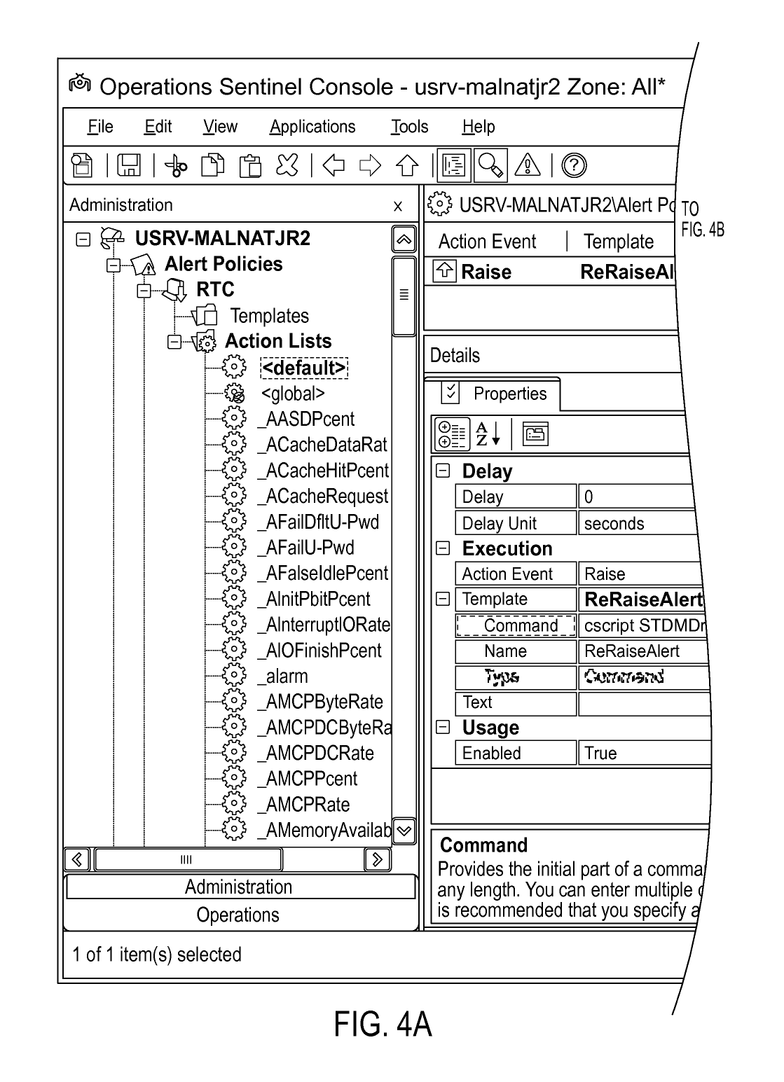

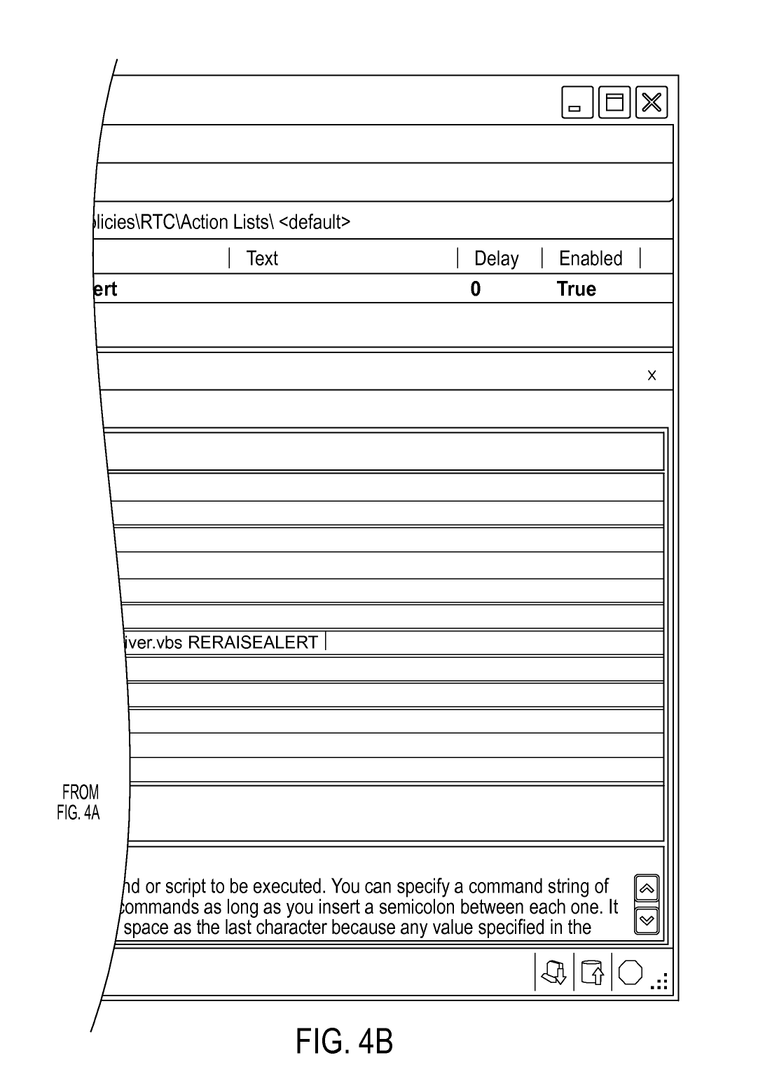

FIG. 4 shows a screen capture of the default Action List in the Alert Policy in Operations Sentinel.

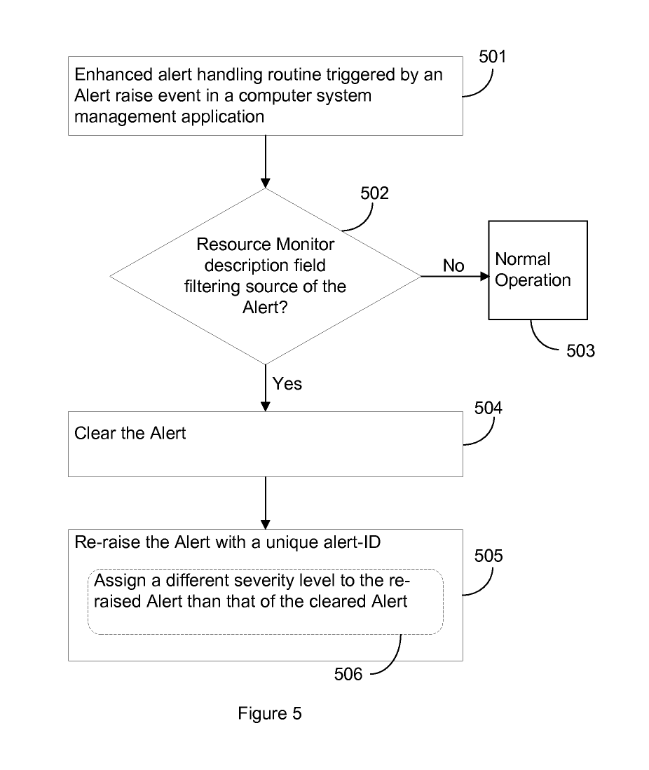

FIG. 5 shows an exemplary operational flow diagram for one embodiment of the present disclosure. As shown, in operational block 501, an enhanced alert handling routine is triggered by an Alert raise event in a computer system management application. That is, an Alert raise event occurring within a computer system management application triggers execution of the enhanced alert handling routine for processing of the raised Alert. The enhanced alert handling routine may be computer-executable software code stored to a computer-readable medium and executing on one or more processor-based devices. The enhanced alert handling routine may be a stand-alone computer-executable software program, or it may be implemented as a part of (e.g., subroutine, etc.) a larger computer-executable software program, such as part of the computer system management application.

In operational block 502, the enhanced alert handling routine analyzes the attributes of the raised Alert and determines whether description field filtering by a Resource Monitor (e.g., Windows Resource Monitor executing on a managed Windows computer system) was the source of the Alert. For instance, the enhanced alert handling routine determines whether a user-defined description field filtering is performed by a resource monitor executing on a managed computer system for raising the Alert as matching an entry in an Operating System (e.g., Windows) event log. If determined in block 502 that such description field filtering by a Resource Monitor was not the source of the raised Alert, then normal operation proceeds (e.g., as otherwise defined by the computer system management application) in block 503.

If determined in block 502 that description field filtering by a Resource Monitor was the source of the raised Alert, then operation advances to block 504 whereat the enhanced alert handling routine clears the raised Alert. In operational block 505, the enhanced alert handling routine re-raises the Alert (e.g., using Operations Sentinel Pipe or Application Programming Interface (API)) with a unique alert-ID. Because the Alert is re-raised with a unique alert-ID, it does not appear as a duplicate and is thus not discarded as a duplicate.

Further, as indicated in optional sub-block 506, the enhanced alert handling routine may assign the re-raised Alert a different severity level than that assigned to the cleared Alert. Thus, greater flexibility is afforded to assignment of severity level to the re-raised Alert by the enhanced alert handling routine, rather than being restricted to assigning statically-defined alert levels for the alerts arising from the resource monitor description field filtering. As mentioned above, in one embodiment, any of the following levels may be automatically selected after the event handling routine parses the alert text and/or other attributes:
Indeterminate
Informational
Warning
Minor
Major
Critical
The alert may also be automatically cleared (and not re-raised) if necessary.
   In certain embodiments, user-defined rules (e.g., associated with the user-defined description field filtering that gave rise to the Alert) may be used by the alert handling routine for selecting (e.g., by processing the alert text and/or other attributes against the user-defined rules) the appropriate severity level to assign the re-raised Alert.

In the past, Description Field Filtering in WRM was largely unusable, due to its alerting inflexibility. Embodiments of the enhanced alert handling described herein make it possible to raise multiple alerts and change their severity (or other attributes), thereby providing the desired flexibility to make this an effective tool within a computer system management application.

It is recognized that the above systems and methods operate using computer hardware and software in any of a variety of configurations. Such configurations can include computing devices, which generally include a processing device, one or more computer readable media, and a communication device. Other embodiments of a computing device are possible as well. For example, a computing device can include a user interface, an operating system, and one or more software applications. Several exemplary computing devices include a personal computer (PC), a laptop computer, or a personal digital assistant (PDA). A computing device can also include one or more servers, one or more mass storage databases, and/or other resources.

A processing device is a device that processes a set of instructions. Several examples of a processing device include a microprocessor, a central processing unit, a microcontroller, a field programmable gate array, and others. Further, processing devices may be of any general variety such as reduced instruction set computing devices, complex instruction set computing devices, or specially designed processing devices such as an application-specific integrated circuit device.

Computer-readable media includes volatile memory and non-volatile memory and can be implemented in any method or technology for the storage of information such as computer-readable instructions, data structures, program modules, or other data. In certain embodiments, computer-readable media is integrated as part of the processing device. In other embodiments, computer-readable media is separate from or in addition to that of the processing device. Further, in general, computer-readable media can be removable or non-removable. Several examples of computer-readable media include, RAM, ROM, EEPROM and other flash memory technologies, CD-ROM, digital versatile disks (DVD) or other optical storage devices, magnetic cassettes, magnetic tape, magnetic disk storage or other magnetic storage devices, or any other medium that can be used to store desired information and that can be accessed by a computing device. In other embodiments, computer-readable media can be configured as a mass storage database that can be used to store a structured collection of data accessible by a computing device.

A communications device establishes a data connection that allows a computing device to communicate with one or more other computing devices via any number of standard or specialized communication interfaces such as, for example, a universal serial bus (USB), 802.11 a/b/g network, radio frequency, infrared, serial, or any other data connection. In general, the communication between one or more computing devices configured with one or more communication devices is accomplished via a network such as any of a number of wireless or hardwired WAN, LAN, SAN, Internet, or other packet-based or port-based communication networks.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein (such as that described in FIG. 5 above) may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary designs, the functions described may be implemented in hardware, software, firmware, or any combination thereof If implemented in software, the functions may be stored as one or more instructions or code on a computer-readable medium which are processed/executed by one or more processors.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for enhanced alert handling for computer system management, the method comprising:
triggering, responsive to an Alert raise event occurring in a computer system management application, an enhanced alert handling routine executing on a processor-based device;
determining, by the enhanced alert handling routine, whether description field filtering by a resource monitor was the source of the Alert; and
when determined that the description field filtering was the source of the Alert, clearing, by the enhanced alert handling routine, the raised Alert, and re-raising, by the enhanced alert handling routine, the Alert with a unique alert-ID.

2. The method of claim 1 wherein the enhanced alert handling routine comprises computer-executable software code stored to a computer-readable medium and executing on one or more processor-based devices.

3. The method of claim 1 wherein said determining further comprises:
analyzing one or more attributes of the Alert.

4. The method of claim 1 wherein said determining comprises:
determining whether a user-defined description field filtering is performed by the resource monitor for raising the Alert as matching an entry in an operating system event log.

5. The method of claim 1 wherein said determining comprises:
determining whether a user-defined description matching an entry in an operating system event log for a managed computer system was the source of the Alert.

6. The method of claim 5 wherein the resource monitor is a Windows Resource Monitor executing on the managed computer system, and wherein the managed computer system has a Windows-based operating system.

7. The method of claim 1 wherein said re-raising further comprises:
assigning, by the enhanced alert handling routine, the re-raised Alert a different severity level than that assigned to the cleared Alert.

8. The method of claim 7 wherein the assigning comprises assigning the re-raised Alert one of the following severity levels: indeterminate, informational, warning, minor, major, and critical.

9. The method of claim 7 wherein said assigning comprises:
parsing at least one of text contained in the re-raised Alert and other attributes of the re-raised Alert, resulting in parsed information; and
processing the parsed information against a user-defined rule to determine said different severity level to assign the re-raised Alert.

10. A computer program product having a computer-readable medium having computer program logic recorded thereon for enhanced alert for computer system management, the computer program product comprising:
code for determining whether a source of an Alert that is raised by a computer system management application for a managed computer system was matching of a user-defined description in an operating system event log for the managed computer system; and
code, responsive to determining that the matching was the source of the Alert, for clearing the Alert and re-raising the Alert with a unique alert-ID.

11. The computer program product of claim 10 wherein the matching is performed by a resource monitor on the managed computer system for raising the Alert.

12. The computer program product of claim 11 wherein the resource monitor is a Windows Resource Monitor executing on the managed computer system, and wherein the managed computer system has a Windows-based operating system.

13. The computer program product of claim 10 wherein said code for re-raising further comprises:
code for assigning the re-raised Alert a different severity level than that assigned to the cleared Alert.

14. The computer program product of claim 13 wherein said code for assigning comprises:
code for parsing at least one of text contained in the re-raised Alert and other attributes of the re-raised Alert, resulting in parsed information; and
code for processing the parsed information against a user-defined rule to determine said different severity level to assign the re-raised Alert.

15. A system for enhanced alert handling for computer system management, the system comprising:
a resource monitor executing on a managed computer system for raising an Alert responsive to determination that a user-defined description matches an entry in an operating system event log;
an enhanced alert handling routine executing on a processor-based device configured to clear the Alert and re-raise the Alert with a unique alert-ID.

16. The system of claim 15 wherein said enhanced alert handling routine is further configured to determine whether the source of the Alert was the resource monitor.

17. The system of claim 15 wherein said enhanced alert handling routine is further configured to assign the re-raised Alert a different severity level than that assigned to the cleared Alert.

18. A system for enhanced alert handling for computer system management, the system comprising:
means for triggering, responsive to an Alert raise event occurring in a computer system management application, an enhanced alert handling routine executing on a processor-based device;
means for determining whether a source of the Alert was matching of a user-defined description in an operating system event log for a managed computer system; and
means, responsive to determining that the matching was the source of the Alert, for clearing the Alert and re-raising the Alert with a unique alert-ID.

19. The system of claim 18 further comprising:
means for assigning the re-raised Alert a different severity level than that assigned to the cleared Alert.

20. The system of claim 18 further comprising:
means for determining, based on processing of at least one attribute of the re-raised alert against a user-defined rule, a severity level to assign to the re-raised Alert.
